(19) United States
(12) Patent Application Publication
(10) Pub. No.: US 2001/0025152 A1
(43) Pub. Date: Sep. 27, 2001

(54) Detergent container with massage brush

(75) Inventors: Hirokazu Sakai, Tokyo (JP); Hiroyuki Hasegawa, Tokyo (JP); Koji Tanaka, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Kao Corporation, Tokyo (JP)

(21) Appl. No.: 09/760,786

(22) Filed: Jan. 17, 2001

(30) Foreign Application Priority Data
Jan. 24, 2000 (JP) 2000-13661

(51) Int. Cl. A61H 7/00

(52) U.S. Cl. 601/17; 601/137

(57) ABSTRACT

A detergent container with a massage brush comprises a body having an opening at the top and a cover which covers the upper part of the body including the opening. The cover has a flat side and has a plurality of projections on the flat side.

### BACKGROUND OF THE INVENTION

The present invention relates to a detergent container and, more particularly, a detergent container with a massage brush having a cover serving as a brush for applying a sufficient massage.

Japanese Patent Laid-Open No. 10-248634 discloses a detergent container of which the cover has a plurality of projections on its top or bottom side so that the cover may be used as a brush in shampooing.

According to the disclosure, the area having projections (hereinafter referred to as a brushing surface) is usually not larger than the area of the bottom of the container since the projections are situated on its top or bottom side. Detergent containers for the contemplated use being not so large at their bottom, the brushing surface of the proposed container is not wide enough to produce a sufficient massage effect. Further, the body of the container and the cover do not form a unitary shape. If the cover is designed to have a large area of the brushing surface, it is very difficult for the body and the cover fitted together to form a unitary shape.

### SUMMARY OF THE INVENTION

An object of the present invention is to provide a detergent container with a massage brush having a sufficient brushing area for producing a satisfactory massage effect irrespective of the size of the container.

Another object of the present invention is to provide a detergent container with a massage brush on the cover thereof, the container and the cover making a unitary form when fitted together.

The above objects are accomplished by a detergent container with a massage brush comprising a body having an opening at the top thereof and a cover which covers the upper part of the body including the opening, wherein the cover has a flat side and has a plurality of projections on that flat side.

### BRIEF DESCRIPTION OF THE DRAWINGS

The present invention will be more particularly described with reference to the accompanying drawings, in which:

FIG. 1 shows a first embodiment of the detergent container with a massage brush according to the present invention, in which FIG. 1A is a perspective view of the container with the cover fitted onto the body, and FIG. 1B is a perspective view of the container with the cover removed from the body;

FIG. 2 shows the essential part of a second embodiment of the detergent container with a massage brush according to the present invention, in which a side cover is being fitted to the cover;

FIG. 3 shows a third embodiment of the detergent container with a massage brush according to the present invention, in which FIG. 3A is a perspective view of the container with the cover fitted on the body, and FIG. 3B is a perspective view of the container with the cover removed from the body;

FIG. 4 shows a fourth embodiment of the detergent container with a massage brush according to the present invention, in which FIG. 4A is a perspective view of the container with the cover fitted on the body, and FIG. 4B is a perspective view of the container with the cover removed from the body; and

FIG. 5 shows a fifth embodiment of the detergent container with a massage brush according to the present invention, in which FIG. 5A is a plan view, FIG. 5B is a front view, FIG. 5C is a side view, and FIG. 5D is a back view of the container with the cover fitted on the body; and FIG. 5E is a side view of the upper part of the body with the cover removed, FIG. 5F is a back view of the part shown in FIG. 5E, and FIG. 5G is a plan view of the part shown in FIG. 5E.

### DETAILED DESCRIPTION OF THE PREFERRED EMBODIMENTS

The detergent container with a massage brush according to the present invention will be described with reference to its preferred embodiments by way of the accompanying drawings.

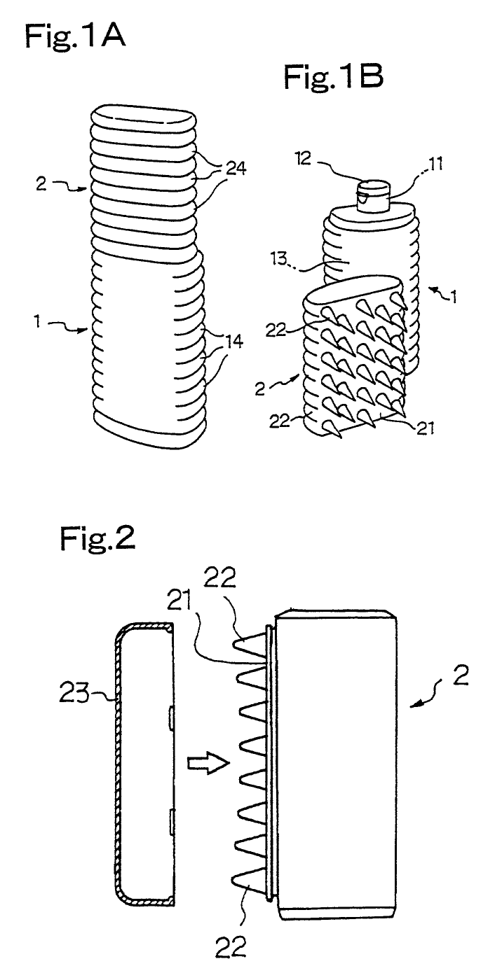

As shown in FIG. 1, the detergent container with a massage brush according to the first embodiment of the invention has a body 1 having an opening 11 with an inner cover 12 at the top thereof and a cover 2 that fits on the upper part of the body 1 to cover the upper side of the body including the opening 11. The cover 2 has a flat side 21 provided with a plurality of projections 22. The opening 11 is at about the center of the upper side of the body 1. The body 1 and the cover 2 make a unitary body when fitted together.

The cover 2 is a flat cylinder having a plurality of upright projections 22 disposed in rows and lines on its flat side 21. Each projection 22 is almost conical and has a nearly semispherical tip. The cover 2 is designed so that it is used as a brush to give a massage to the scalp with its projections 22. The other part of the cover 2 (flat cylinder) than the brushing surface has corrugations 24 in the circumferential direction to make a good appearance and to avoid a slip while grasped in a users hand.

The body 1 has a hollow portion 13 thereof formed by, for example, blow molding, in which a detergent such as a shampoo is put. The detergent in the hollow portion 13 of the body 1 can be dispensed from the opening 11 by pushing the body 1 with the opening 11 down. Corrugations 14 similar to the corrugations 24 of the cover 2 are made on part of the peripheral surface of the body 1.

While the detergent container of the first embodiment is not used, the opening 11 of the body 1 is closed with the inner cover 12, and the upper side of the body 1 including the opening 11 is covered with the cover 2. On use, the cover 2 is removed from the body 1, the inner cover 12 is removed, and the opening 11 is exposed. The cover 2 is shaped to form a unitary body with the body 1. It is preferred for the cover 2 to fit with the body 1 and be separated therefrom on use.

The detergent container with a massage brush according to the second embodiment has, as shown in FIG. 2, a side cover 23 which covers the brushing surface 21 of the cover 2. With the side cover 23 on, the brushing surface 21 having projections 22 is covered. With the side cover 23 off, the brushing surface 21 having projections 22 is exposed. It is preferred for the side cover 23 attached to the cover 2 to make a unitary body with the cover 2 and the body 1.

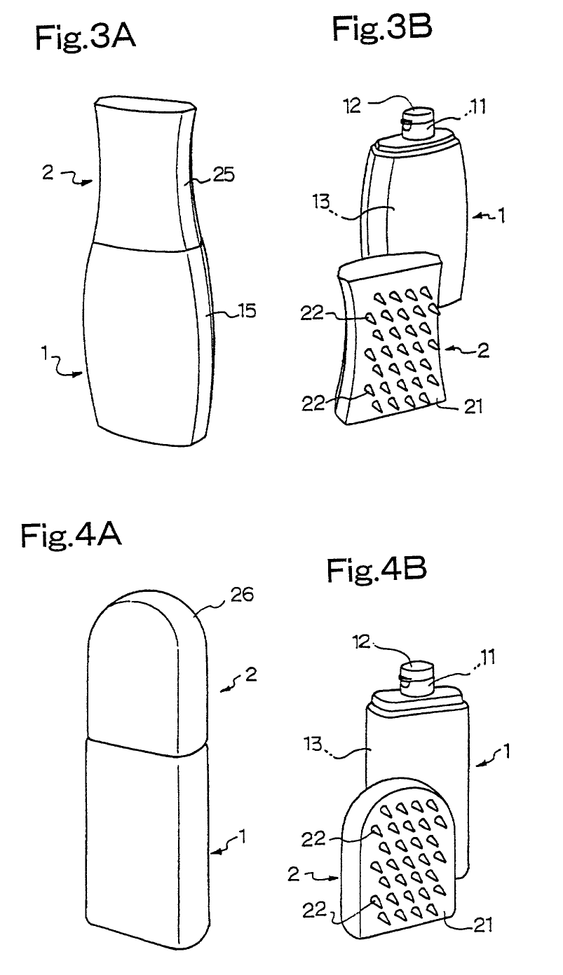

The detergent container with a massage brush according to the third embodiment is shown in FIG. 3. The cover 2 has a curved surface 25 on a part of the area with no projections 22, and a part of the body 1 also has a curved surface 15 in such a manner that the curved surfaces 25 and 15 have continuity when the cover 2 is fitted on the body 1. Neither the body 1 nor the cover 2 has corrugations 14 and 24 of the first embodiment. If desired, a plurality of small grooves may be provided on the body 1 and the cover 2 for slip prevention.

The detergent container with a massage brush according to the fourth embodiment is shown in FIG. 4. The cover 2 has its shoulders 26 rounded to make an arch. Neither the body 1 nor the cover 2 has corrugations 14 and 24 of the first embodiment. If desired, a plurality of small grooves may be provided on the body 1 and the cover 2 for slip prevention.

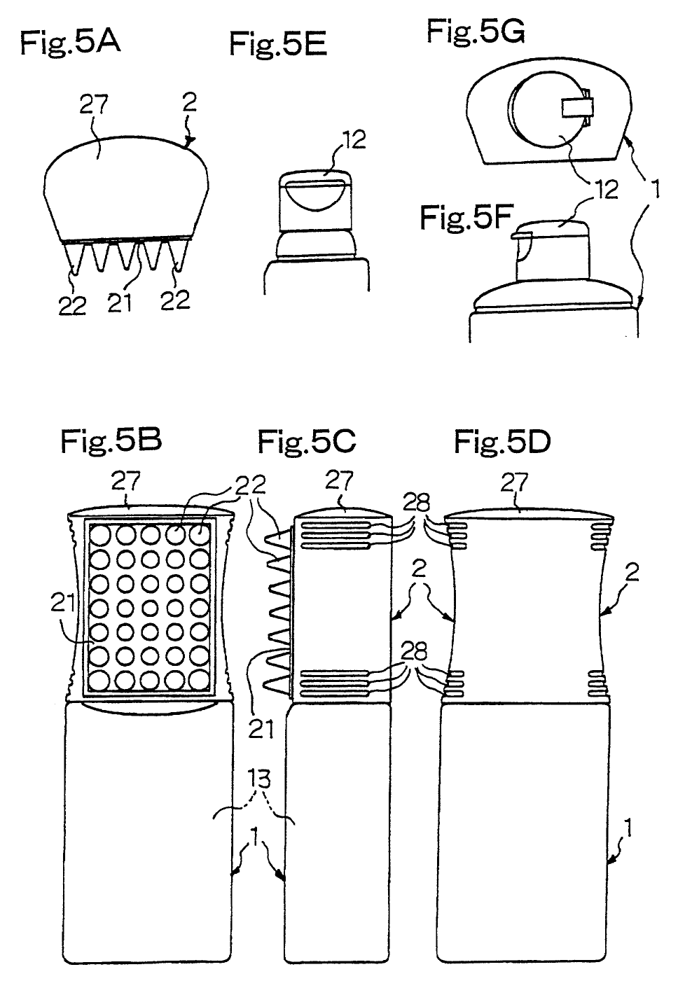

The detergent container with a massage brush according to the fifth embodiment is shown in FIG. 5. The projections 22 are arranged on the cover 2 in a configuration effective for a massage. As shown in FIGS. 5A through 5G, while the body 1 and the cover 2 are substantially the same in form as those of the first embodiment, the projections 22 on the cover 2, which are arranged in rows and lines, are similar but different in height and base diameter in such a manner that their apices form an imaginary concave plane (curved inward in the middle) as shown in FIGS. 5A to 5C. In more detail, the projections 22 on every edge of the brushing surface in its front view (FIG. 5B) are the highest, and the height is decreasing from these edges toward the center as shown in the plan view (FIG. 5A) and the side view (FIG. 5C).

As shown in FIGS. 5B to 5D, the top side 27 of the cover 2 has a convex surface (curved outward) so that the cover 2 removed from the body 1 cannot stand upside down and does not allow water, etc. to collect therein. The cover 2 has three grooves on each of the upper and the lower parts of its both side surfaces to make a unique design while reducing the amount of the resin forming the cover 2.

The construction of the second to fifth embodiments is the same as the first embodiment's except for the above-mentioned alterations to the design. The constituent elements common to the first to fifth embodiments are given the same reference numerals, and the description therefor is not repeated.

The side cover of the second embodiment can be adopted to the detergent containers of the third to fifth embodiments. The configuration of the projections of the fifth embodiment can be applied to the first to fourth embodiments.

In order to give an improved massage to the scalp, the projections in the above-described embodiments preferably have the following hardness, dimensions, configuration and density.

To give a comfortable feel in applying a scalp massage, the projections preferably have a Shore hardness (JIS G0202) of 20 to 80. A preferred material of the projections is an elastomer consist of styrene butadiene block copolymer. Other materials include styrene butadiene rubber (copolymer), ethylene propylene rubber, a blend of nitrile rubber and polyvinyl chloride, chloroprene rubber, and chlorosulfonated polyethylene rubber. In order for the projections to slide easily on the scalp and to give a comfortable feel to the scalp, the rounded tip of the projections preferably has a curvature radius of 0.5 to 4 mm. In order to give a comfortable feel to the scalp and to secure moderate elasticity of the projections, the base of the projections preferably has a diameter of 5 to 10 mm. A preferred height of the projections for securing a smooth comb through hair is 8 to 12 mm. The configuration of the projections may be at random but is preferably orderly for a smooth comb. In order to secure satisfactory massage efficiency and washing efficiency, the density of the projections on the brushing surface is preferably 0.5 to 2.0 projections per cm².

Not all the projections need to have the same contour. For example, they can have their height, base size, and the like varied continuously or locally according to the position on the brushing surface.

The detergent which can be put in the container of the present invention and is suited for applying a scalp massage includes, but is not limited to, a detergent composition comprising 0.1 to 10 parts by weight of a cationic polymer, 1.0 to 50 parts by weight of a nonionic surface active agent, 1.0 to 50 parts by weight of an alcohol, and water in an amount making 100 parts by weight.

The cationic polymer includes cationic cellulose, a homopolymer of a diallyl quaternary ammonium salt, a diallyl quaternary ammonium salt/acrylamide copolymer, a quaternized polyvinylpyrrolidone derivative, cationic hydrogel, and a cationic group-containing copolymer obtained by radical polymerization of a monomer mixture essentially comprising a cationic group-containing vinyl monomer (e.g., N,N-dimethylaminoethylmethacrylic acid diethylsulfate), a hydrophilic nonionic group-containing vinyl monomer (e.g., N,N-dimethylacrylamide), and a crosslinking vinyl monomer having two or more vinyl groups per molecule (e.g., polyoxyethylene glycol dimethacrylate). The nonionic surface active agent includes polyoxyethylene alkyl ethers, polyoxyethylene hydrogenated castor oil, polyoxyethylene sorbitan fatty acid esters, higher fatty acid (C₁₀-C₂₄) glycerol esters, alkylamine oxides, and alkyl saccharides. The alcohols include ethanol, propylene glycol, butylene glycol, polyethylene glycol, glycerol, and sorbitol. Common detergents comprising anionic surface active agents or amphoteric surface active agents are also useful.

The use of the detergent container according to the present invention will be illustrated as for the second embodiment for instance. The hollow portion of the body 1 contains a prescribed detergent. The opening 11 is closed with the inner cover 12. The upper side of the body 1 including the opening 11 is covered with the cover 2, and the brushing surface (the side 21 with projections 22) of the cover is covered with the side cover 23.

On use the side cover 23 is removed from the cover 2, the cover 2 is removed from the body 1, the inner cover 12 is removed from the opening 11, and the opening 11 is exposed. The detergent is pushed out from the opening 11 for shampooing. During shampooing, the cover 2 apart from the body 1 is used as a massage brush.

The cover 1 can be used as a brush for a scalp massage in shampooing to give roots of hair physical stimulation to accelerate hair growth.

The detergent containers of the first and the third to fifth embodiments are used in the same manner as described above, except for the attachment and detachment of the side cover.

According to the first to fifth embodiments, the brushing surface of the cover 2 can be made wide enough to produce a satisfactory massage effect irrespective of the size of the body 1 of the container.

According to the first to fifth embodiments, since the body 1 has the inner cover 12, there is no fear that the contents may be spilled from the opening 11, or water, etc. may enter the hollow portion 13 from the opening 11 while the cover 2 is separated from the body 1 for use as a massage brush.

According to the first to fifth embodiments, the body 1 and the cover 2 attached to the top of the body 1 being designed to make a unitary body, the detergent containers of the present invention have a neat appearance.

Having the side cover 23, the detergent container of the second embodiment has advantages in that it is hygienic and is beautifully displayed in the stores in addition to the above-described effects.

Since the projections 22 of the detergent container of the fifth embodiment have decreasing heights toward the center of the brushing surface to form an imaginary concave plane, the projections 22 fit the curved skin of the head to give a greater massage effect.

The invention having been thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A detergent container with a massage brush comprising a body having an opening at the top and a cover which covers the upper part of the body including said opening, wherein said cover has a flat side and has a plurality of projections on said flat side.

2. The detergent container with a massage brush according to claim 1, wherein said opening is at about the center of the upper side of said body and has an inner cover with which it is closed.

3. The detergent container with a massage brush according to claim 1, which further comprises a side cover with which said flat side having said projections is covered.

4. The detergent container with a massage brush according to claim 1, wherein said body and said cover are designed to form a unitary body when fitted together.
